(19) United States
(12) Patent Application Publication
(10) Pub. No.: US 2023/0132061 A1
(43) Pub. Date: Apr. 27, 2023

(54) INFORMATION EXTRACTION FROM DOCUMENT CORPORA

(71) Applicant: International Business Machines Corporation, Armonk, NY (US)

(72) Inventors: Birgit Monika Pfitzmann, Wettswil (CH); Christoph Auer, Zurich (CH); Kasper Dinkla, Adliswil (CH); Michele Dolfi, Zurich (CH); Peter Willem Jan Staar, Zurich (CH)

(21) Appl. No.: 17/508,117

(22) Filed: Oct. 22, 2021

(51) Int. Cl. G06N 5/04; G06F 40/284; G06F 40/295; G06K 9/00; G06N 5/02

(52) U.S. Cl. CPC G06N 5/04; G06F 40/284; G06F 40/295; G06K 9/00469; G06N 5/02

(57) ABSTRACT

Information extraction systems and computer-implemented methods for producing a searchable representation of information contained in a corpus of documents by generating a document structure graph for each document, the graph indicating a structural hierarchy of document items in that document based on a predefined hierarchy of predetermined item-types, and linking document items to a parent document item in the structural hierarchy, for each document, generating a knowledge graph including first nodes, representing document items in the corpus and second nodes representing language items identified in those document items, interconnecting the first nodes and second nodes by edges representing a defined relation between items represented by the nodes interconnected by that edge, storing the knowledge graph in a knowledge graph database, and producing the searchable representation by traversing edges of the graph in response to input search queries.

### BACKGROUND

The present invention relates generally to extraction of information from document corpora. Computer-implemented methods are provided for producing a searchable representation of information contained in a corpus of documents. Information extraction systems and computer program products implementing such methods are also provided.

The publication of scientific papers, articles and other technical documents has increased exponentially over the last few decades. These documents provide a vast repository of technological knowledge, calling for systems which can make this knowledge discoverable and usable to further advance technology. Extracting knowledge from large document collections is an important strategy in numerous technical applications, such as materials science, the oil and gas industry, and medical applications such as disease analysis and treatment development.

Knowledge graphs are well-known data structures for representing information derived from a large corpus of documents. A knowledge graph essentially comprises nodes, which represent particular entities about which associated information is stored, interconnected by edges which represent defined relations between entities. To generate a knowledge graph for a document corpus, machine learning models trained to implement NLP (Natural Language Processing) tasks are applied to the documents to extract entities and relations from the text. Entities here may be document items, such as paragraphs, images, tables, and so on, as well as language items such as words or phrases defining particular things, or types or properties of things, contained in those document items. Language items and their relationships can be identified using various NLP techniques. For example, NER (Named Entity Recognition) models can be trained to identify words/phrases defining particular entities and annotate these by type, such as polymer classes, polymer names, material properties, and so on. NLP relation models can analyze text to identify relations between two entities X and Y, such as X “is a type of” Y, or X “is a property of” Y, where text in quotation marks defines the relation.

“Corpus Conversion Service: A Machine Learning Platform to Ingest Documents at Scale”, Peter Staar et al., KDD 2018: 774-782, describes a system for identifying particular types of document items (titles, subtitles, text paragraphs, figures, etc.) in documents to produce an annotated list of the items contained in each document in a corpus. “Corpus Processing Service: A Knowledge Graph Platform to perform deep data exploration on corpora”, Peter Staar at al., Authorea, Sep. 16, 2020, describes a system which uses NLP techniques to process the individual document items in these lists to identify entities/relations and generate a knowledge graph for a corpus. The resulting knowledge graph can be loaded to a database for querying and searching the graph.

The ultimate goal of such information extraction systems is to extract all relevant information from documents with regard to the domain of a document corpus. Different technical domains require different annotations and hence models trained to identify the particular entities and relations relevant to a given domain. NLP models for identifying relations are typically based on closeness of entities in the original text. In generic models, closeness is often the only criterion. Some models also use grammar analysis, but this is inherently local by sentence.

Extracting all relevant information from a document corpus is an extremely challenging task. In view of the wealth of information contained in these corpora, improved information extraction techniques would be highly desirable.

### SUMMARY

One aspect of the present invention provides a computer-implemented method for producing a searchable representation of information contained in a corpus of documents by generating a document structure graph, the graph indicating a structural hierarchy of document items in that document based on a predefined hierarchy of predetermined item-types, and linking document items to a parent document item in the structural hierarchy, for each document, generating a knowledge graph including first nodes, representing document items in the corpus and second nodes representing language items identified in those document items, interconnecting the first nodes and second nodes by edges representing a defined relation between items represented by the nodes interconnected by that edge, storing the knowledge graph in a knowledge graph database, and producing the searchable representation by traversing edges of the graph in response to input search queries.

Another aspect of the invention provides an information extraction system for producing a searchable representation of information contained in a corpus of documents each comprising a succession of document items of predetermined item-types defined for the corpus. The system comprises: memory for storing the documents, document graph logic adapted to generate a document structure graph as described above for each document, a knowledge graph generator adapted to generate a knowledge graph including edges representing parent-child relations as described above, and a knowledge graph database for storing the knowledge graph to produce the searchable representation of information contained in the corpus, wherein the knowledge graph database is adapted to search the knowledge graph by traversing edges of the graph, in response to input search queries.

A further aspect of the invention provides a computer program product comprising a computer readable storage medium embodying program instructions, executable by a computing system, to cause the computing system to implement a method described above for producing a searchable representation of information contained in a document corpus.

Embodiments of the invention will be described in more detail below, by way of illustrative and non-limiting example, with reference to the accompanying drawings.

### BRIEF DESCRIPTION OF THE SEVERAL VIEWS OF THE DRAWINGS

FIG. 1 is a schematic representation of a computing system for implementing methods embodying the invention;

FIG. 2 illustrates component modules of a computing system implementing an information extraction system embodying the invention;

FIG. 3 indicates steps performed in operation of the FIG. 2 system;

FIG. 4 indicates steps performed in operation of the FIG. 2 system;

FIG. 5 is a schematic representation of a document structure graph produced by the FIG. 2 system;

FIG. 6a indicates steps of a recursive process for generating a document structure graph in a preferred embodiment;

FIG. 6b indicates steps of a recursive process for generating a document structure graph in a preferred embodiment;

FIG. 7 shows program code for generating parent-child edges in a knowledge graph in an embodiment of the system;

FIG. 8 is a schematic representation of nodes and edges in an exemplary knowledge graph generated by the system;

FIG. 9 is a schematic illustrating additional edges included in knowledge graphs by embodiments of the system; and

FIGS. 10 and 11 illustrates features of a graphical user interface provided in preferred embodiments of the system.

### DETAILED DESCRIPTION

By providing parent-child edges in the knowledge graph based on the document structure graphs for documents, methods embodying the invention assimilate the structures of the documents themselves in the overall knowledge representation. Information which is implicit in the hierarchical structure of a document as a whole can be embedded in the knowledge graph and extracted via search operations. The structural layout of a document, such as titles, section headers, and sub-headers for sub-sections at various nested levels, expresses valuable information that may not otherwise be expressed in the text of individual document items. For example, a key term may be stated in a section header and not repeated in paragraphs under that header, or information in an introductory statement may relate to all items in a subsequent list. Methods embodying the invention can capture such additional information encoded in the structural hierarchy of each document. The resulting knowledge graph thus enables extraction of more information from a corpus than can be derived from individual document items in the documents. This constitutes a significant advance in knowledge extraction systems, offering improved search processes, better search results, and better solutions to the real-life problems supported by these searches.

It will be appreciated that edges representing parent-child relations in the knowledge graph indicate which document items are subordinate/superior to which other items in the document structure. By traversing these edges, information implicit in this hierarchical relationship can be extracted in search operations. As explained further below, parent-child edges can be exploited in user-constructed search queries, and/or predefined template search queries, to extract this information and provide more comprehensive search results. Moreover, parent-child relations can be exploited by NLP processes to deduce new relations between language items in related document items. This results in new edges in the knowledge graph between nodes representing these items, further supplementing the body of knowledge represented in the graph. By way of example, it may be deduced that a term mentioned in a paragraph with a parent section header is a particular example of a more generic term appearing in that header. In general, relations expressly or implicitly encoded in the knowledge graph produced by embodiments of the invention are not limited to proximity of terms in individual documents items or by grammatical analysis of individual sentences.

Knowledge graphs generated by methods embodying the invention may further include edges, representing ancestral relations, between nodes representing document items in each document and nodes representing at least one ancestor of their respective parent document items in the structural hierarchy for that document. Such knowledge graphs can therefore include direct edges between a document item node and nodes representing the parent-of-its-parent document item, the grandparent of its parent document item, and so on up to a desired hierarchy level in the document structure graph. These direct ancestral edges offer more flexible and efficient search operations. For example, multiple ancestral edges may be traversed in parallel to retrieve information associated with multiple ancestors or descendants of a given node. In addition, NLP relation models may be applied to deduce relations between language items in document items and language items in ancestors of those document items in the structural hierarchy of a document, resulting in additional edges explicitly encoding these relations in the knowledge graph.

Advantageously, knowledge graphs produced by embodiments of the invention can also include edges, representing neighbor relations, between nodes representing document items in each document and nodes representing their respective succeeding document items in the succession of document items for that document. These edges allow potentially relevant information to be retrieved from neighboring documents items, such as neighboring paragraphs, which often contain text with related information.

Particularly preferred methods include providing a graphical user interface, for display by a user computer, for input of search queries to the knowledge graph database. These methods can provide a mechanism in the interface for selecting traversal of edges representing parent-child relations between document items in search operations for input search queries. Corresponding mechanisms can be included for selecting traversal of edges representing ancestral and/or neighbor relations where provided. In addition, or as an alternative, these methods can provide predefined template search queries using the various structure-derived edges in the interface, where each template, or “search workflow”, defines a particular type of search query which can be further customized to particular user requirements in the interface.

Methods embodying the invention may include a preprocessing step in which each document in a source document corpus is first processed to parse the document into the succession of document items which are annotated with their item-types as predefined for the corpus. However, document structure graphs can be generated from any corpus of documents which have been processed to identify the succession of document items in each document. In preferred embodiments, each document structure graph is generated in a particularly efficient manner via a recursive process. This process identifies a parent document item for each document item, sequentially in order of succession in the document, in dependence on relative location in the predefined item-type hierarchy of the item-type of that item and the item-type of items earlier in the succession. This and other features and advantages of methods embodying the invention will be described in more detail below.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments to be described can be performed as computer-implemented methods for generating a searchable representation of information contained in a document corpus. Such methods may be implemented by a computing system comprising one or more general- or special-purpose computers, each of which may comprise one or more (real or virtual) machines, providing functionality for implementing operations described herein. Steps of methods embodying the invention may be implemented by program instructions, e.g. program modules, implemented by a processing apparatus of the system. Generally, program modules may include routines, programs, objects, components, logic, data structures, and so on that perform particular tasks or implement particular abstract data types. The computing system may be implemented in a distributed computing environment, such as a cloud computing environment, where tasks are performed by remote processing devices that are linked through a communications network. In a distributed computing environment, program modules may be located in both local and remote computer system storage media including memory storage devices.

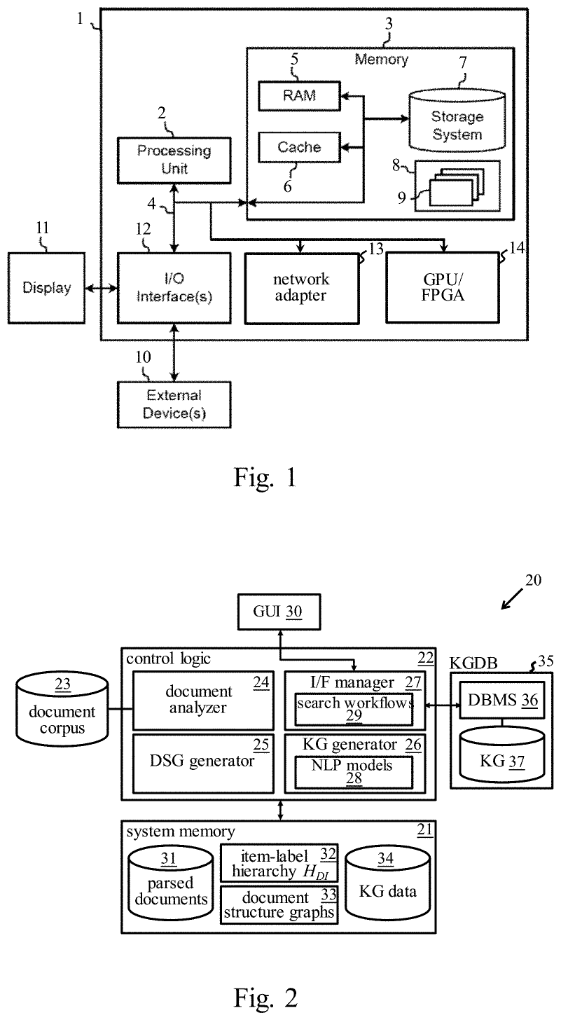

FIG. 1 is a block diagram of exemplary computing apparatus for implementing methods embodying the invention. The computing apparatus is shown in the form of a general-purpose computer 1. The components of computer 1 may include processing apparatus such as one or more processors represented by processing unit 2, a system memory 3, and a bus 4 that couples various system components including system memory 3 to processing unit 2.

Bus 4 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 1 typically includes a variety of computer readable media. Such media may be any available media that is accessible by computer 1 including volatile and non-volatile media, and removable and non-removable media. For example, system memory 3 can include computer readable media in the form of volatile memory, such as random access memory (RAM) 5 and/or cache memory 6. Computer 1 may further include other removable/non-removable, volatile/non-volatile computer system storage media. By way of example only, storage system 7 can be provided for reading from and writing to a non-removable, non-volatile magnetic medium (commonly called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can also be provided. In such instances, each can be connected to bus 4 by one or more data media interfaces.

Memory 3 may include at least one program product having one or more program modules that are configured to carry out functions of embodiments of the invention. By way of example, program/utility 8, having a set (at least one) of program modules 9, may be stored in memory 3, as well as an operating system, one or more application programs, other program modules, and program data. Each of the operating system, one or more application programs, other program modules, and program data, or some combination thereof, may include an implementation of a networking environment. Program modules 9 generally carry out the functions and/or methodologies of embodiments of the invention as described herein.

Computer 1 may also communicate with: one or more external devices 10 such as a keyboard, a pointing device, a display 11, etc.; one or more devices that enable a user to interact with computer 1; and/or any devices (e.g., network card, modem, etc.) that enable computer 1 to communicate with one or more other computing devices. Such communication can occur via Input/Output (I/O) interfaces 12. Also, computer 1 can communicate with one or more networks such as a local area network (LAN), a general wide area network (WAN), and/or a public network (e.g., the Internet) via network adapter 13. As depicted, network adapter 13 communicates with the other components of computer 1 via bus 4. Computer 1 may also communicate with additional processing apparatus 14, such as a GPU (graphics processing unit) or FPGA, for implementing embodiments of the invention. It should be understood that although not shown, other hardware and/or software components could be used in conjunction with computer 1. Examples include, but are not limited to: microcode, device drivers, redundant processing units, external disk drive arrays, RAID systems, tape drives, and data archival storage systems, etc.

The FIG. 2 schematic illustrates component modules of an exemplary computing system implementing an information extraction system embodying the invention. The system 20 comprises memory 21 and control logic, indicated generally at 22, comprising functionality for generating a searchable representation of information in a document corpus 23. In this embodiment, control logic 22 comprises a document analyzer 24, a document structure graph (DSG) generator 25, a knowledge graph (KG) generator 26, and an interface (I/F) manager module 27. Each of these logic modules comprises functionality for implementing particular steps of an information extraction process detailed below. During this process, KG generator 26 employs a set of NLP models as indicated schematically at 28. The I/F manager 27 comprises functionality for providing a graphical user interface (GUI) 30, for display by a user computer, for user interactions with the system. I/F manager 27 may provide a set of predefined search workflows, indicated at 29, for display in GUI 30 as explained below.

Logic modules 24 through 27 interface with memory 21 which stores various data structures used in operation of system 20. These data structures include a parsed document corpus 31, an item-label hierarchy (H_{DI}) 32 which defines a hierarchy of document item-types, a set of document structure graphs 33 produced by DSG generator 25 in operation, and KG data 34 which comprises data defining the nodes, edges and associated metadata for a KG generated by KG generator 26. System 20 further comprises a knowledge graph database (KGDB) 35 comprising a database management system (DBMS) 36 and associated memory 37 for storing a KG which is assembled and loaded to the database for searching.

In general, functionality of logic modules 24 through 27 may be implemented by software (e.g., program modules) or hardware or a combination thereof. Functionality described may be allocated differently between system modules in other embodiments, and functionality of one or more modules may be combined. The various components of system 20 may be provided in one or more computers of a computing system. For example, all modules may be provided in a computer 1 at which GUI 30 is displayed to a user, or modules may be provided in one or more computers/servers to which user computers can connect via a network (which may comprise one or more component networks and/or internetworks, including the Internet). System memory 21 may be implemented by one or memory/storage components associated with one or more computers of system 20.

Document corpus 23 may be local or remote from system 20 and may comprise documents from one or more information sources spanning the domain(s) of interest for a particular application. Documents in this corpus may be distributed over a plurality of information sources, e.g. databases and/or websites, which may be accessed dynamically by the system via a network, or the corpus 23 may be precompiled for system operation and stored in system memory 21.

In KGDB 35, the database management system 36 typically comprises a set of program modules providing functionality for storing and accessing the KG data in database memory 37. Such management systems can be implemented in generally known manner and the particular implementation is orthogonal to the operations described herein. Various data structure formats, of generally known type, can be used for storing the KG in memory 37, and the stored data structures may correspond directly or indirectly to features of the graph. In particular, KGDB 35 may employ native graph storage, which is specifically designed around the structure of the graph, or non-native storage such as a relational or object-orientated database structure. It suffices to understand that, in a knowledge graph database, a knowledge graph is defined at some level of the database model.

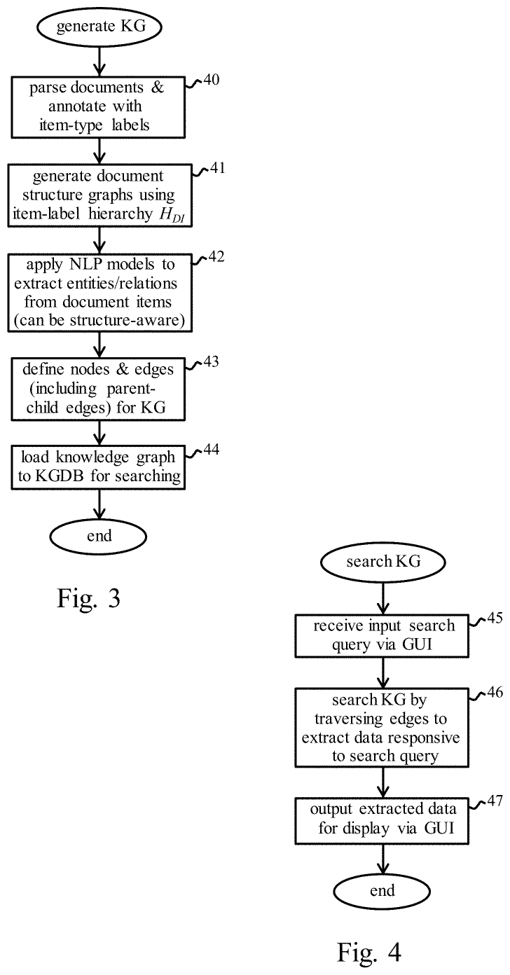

FIG. 3 indicates basic steps of the KG generation process in operation of system 20. In step 40 of this embodiment, the document analyzer 24 processes each document in corpus 23 to parse the document into a succession of document items each annotated with a corresponding document item-type from a set of item-types which are predefined for the corpus. The resulting documents, parsed and annotated with item-type labels, are stored as corpus 31 in system memory 21. In step 41, the DSG generator 25 generates a document structure graph for each document in corpus 31. This document structure graph indicates a structural hierarchy of the document items in the document, based on the predefined item-label hierarchy H_{DI} 32, whereby document items are each linked to a parent document item in the structural hierarchy of that document.

Steps 42 and 43 represent the knowledge graph generation process in KG generator 26. In step 42, the KG generator applies NLP models 28 to extract entities and relations, which will correspond to nodes and edges respectively of the knowledge graph, from documents 31. NLP models applied here may use generally known techniques for identifying and labelling language items as named entities (NEs), and for deducing relations between these language entities by locally analyzing text within individual document items. However, as indicated in brackets in step 42, preferred embodiments can apply “structure-aware” NLP models here. A structure-aware NLP model can exploit document structure as defined by the document structure graphs to derive additional relations between language entities in different document items. This is explained further below.

In step 43, the KG generator 26 generates the knowledge graph elements by storing data defining all nodes and edges of the graph as KG data 34 in system memory 21. Nodes are defined here for respective document items in corpus 31 and also language items identified in those document items in step 42. Edges interconnecting language item nodes are defined for all relations identified in step 42, along with edges connecting document items nodes to nodes representing the language items in each document item. In addition, the KG generator uses the document structure graph (DSG) 33 for each document to define edges, representing parent-child relations, between nodes representing document items in each document and nodes representing their respective parent document items in the structural hierarchy for that document. Various other nodes/edges may be included in the KG as described for particular embodiments below. The resulting KG data, defining all nodes and edges with their associated metadata (such as labels, properties, and/or any other data associated with graph elements) is stored as KG data 34 in system memory 21. In step 44, the resulting knowledge graph is loaded to KGDB 35 and stored in KG memory 37, providing a searchable representation of information contained in the document corpus 23.

The I/F manager 27 of this embodiment provides GUI 30 to assist users with KG searches. This module provides tools for construction of search queries in the GUI, receives input search queries for submission to KGDB 35, and controls presentation of search results in the GUI. In a KG search operation, the I/F manager receives an input search query, as indicated at step 45 of FIG. 4, and submits the query to DBMS 36 of KG database 35. On receipt of the query in step 46, the DBMS searches KG 37 by traversing edges of the graph to extract information responsive to the search query. The extracted information may comprise data associated with relevant nodes and/or edges of the graph in accordance with requirements specified in the search query. In step 47, the extracted information is then output to I/F manager 27 for display to the user via GUI 30.

Steps of the KG generation process are described in more detail in the following. Document analysis step 40 can be implemented using generally known feature extraction techniques for documents in a given format, such as PDF (Portable Document Format) or bitmap images. For example, interpretation of PDF printing commands can identify text characters and groupings for PDF documents generated from computer inputs such as Microsoft Word or Latex applications. OCR (Optical Character Recognition) techniques can also identify text characters in PDF documents produced by scanning, with morphological dilation applied to identify character strings and lines of text. Location of features such as horizontal/vertical lines and spaces, and vertical/horizontal feature alignment, can be used to identify boundaries of items such as paragraphs, pictures, tables, etc., and recognition of text features such as section numbers, capitals and bold type can assist with header and sub-header identification. Such feature extraction techniques can be used to parse each document into a succession of document items in the order of presentation in the textual flow of the document, and label each item with an item-type according to a predefined set of item-type labels for a corpus. Examples of such item-types comprise: document title; subtitle; document author; document abstract; author affiliation; chapter; section heading; subsection heading; paragraph; table; picture; caption; keyword; citation; table-of-contents; list item; sub-list item; table; table column-header; table row-header; table cell; list in table cell; code; form; formula; footnote, and so on. All or a subset of these or other predefined item labels may be used as appropriate for a given document corpus. Labels for subsection headings can specify an associated level to accommodate multiple levels of progressively subordinate subheadings. Levels can be similarly specified in labels for sub-list items, sub-sub-list items, and so on. In a preferred embodiment, document analyzer 24 is implemented using the Corpus Conversion Service (CCS) system described in the reference above. The parsed documents produced by this system are formatted as labeled lists of document items, in reading order of a document, defined in JSON (JavaScript Object Notation) format.

Generation of the DSGs in step 41 of FIG. 3 uses the hierarchy H_{DI} of the item-type labels which is predefined for the labels used in document analyzer 24. The hierarchy H_{DI} for a particular corpus can be defined by a system operator and stored at 32 in system memory 21. The following gives a particular example of a hierarchy H_{DI} used in a DSG generation process detailed below. In this hierarchy list, text in quotes corresponds to a document item label, the following number represents a position in the hierarchy (where larger numbers denote higher hierarchy levels), and text following “#” gives explanatory comment.

Item-type Hierarchy H_{DI}:

“supertitle”: 1000, # this label does not exist (used for initializing the DSG generation process detailed below)
“title”: 200,
“subtitle”, “author”: 190 # Independent items under the title
“affiliation”: 185,
“chapter”: 180,
“section-level-1”: 160,
“section-level-2”: 150,
“section-level-3”: 140,
“section-level-4”: 130,
“section-level-5”: 120,
“paragraph”, “table-of-contents”, “abstract”, “keyword”, “citation”: 100, # Separate items under headings
“list item”: 90, “sub-list item”: 89, “sub-sub-list item”: 88,
“code”, “caption”, “form”, “formula”: 80, # Items that can occur inside normal text
“table”, “picture”: 70, # Subordinate to their captions if present
“column-header”, “row-header”: 60 # Inside tables
“table cell”: 50
“list in table cell”: 40
“footnote”: 10, # As it can also belong to table elements
“nothing”: 0 # Just an initialization value for the DSG generation process below.

CCS labels such as “page-footer” and “page header” for items which are outside the normal text flow of a document are omitted from the above hierarchy and the succession of document items used in the DSG generation process below.

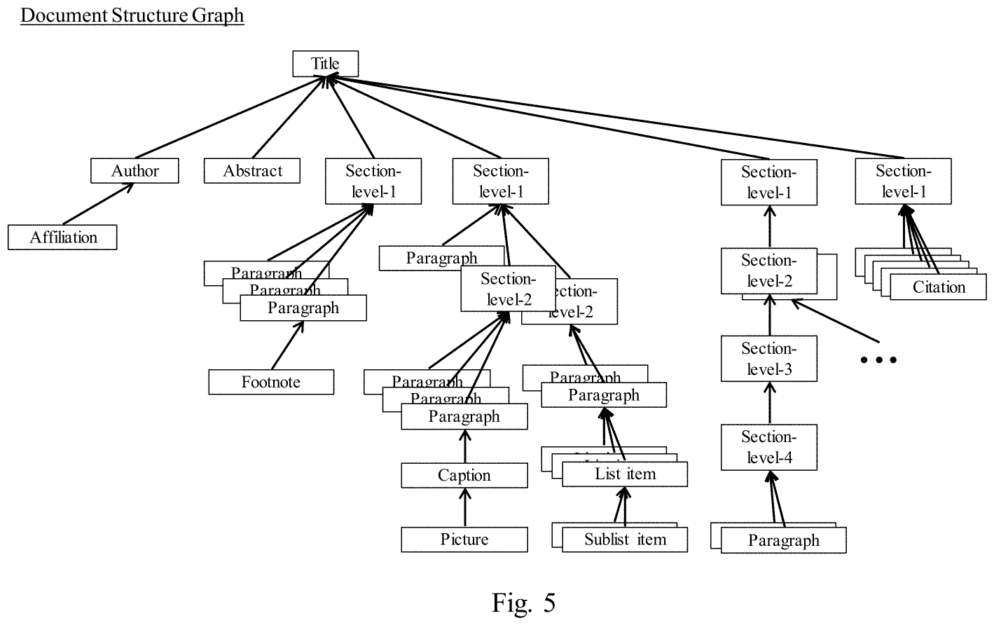

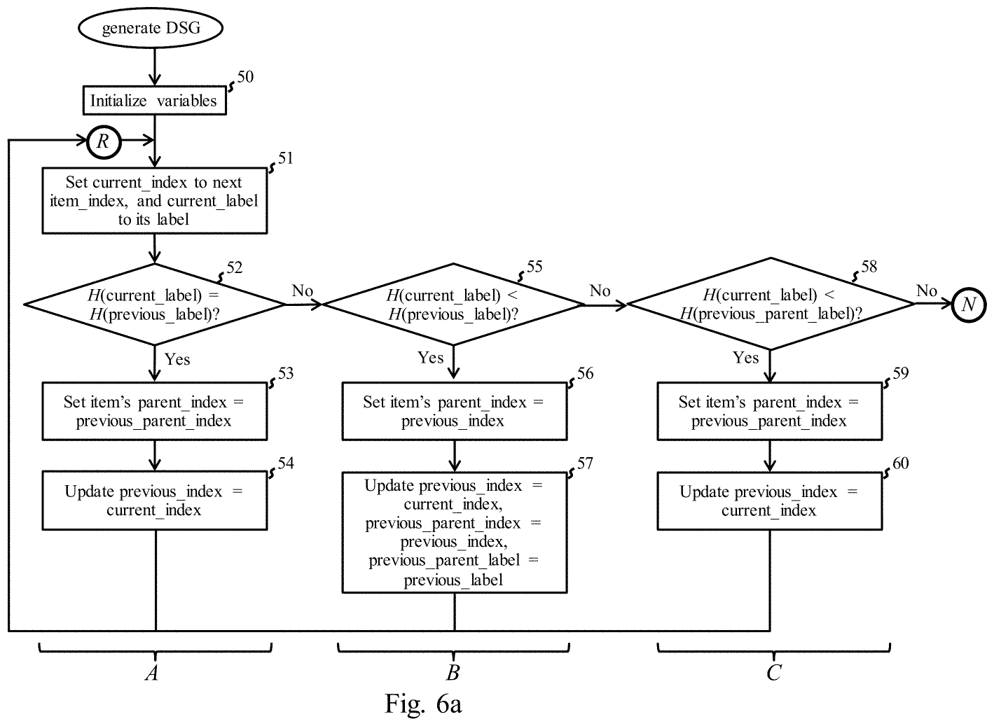

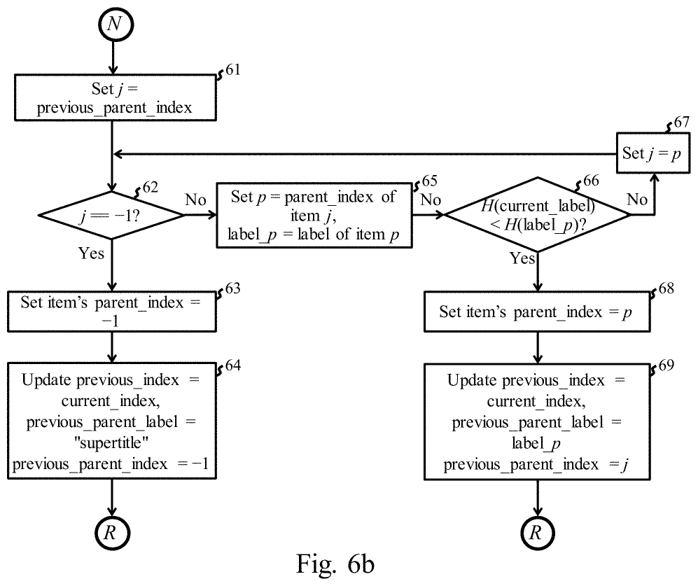

FIG. 5 is a schematic representation of a document structure graph, produced using the above hierarchy, for an exemplary document. Document items are represented in this figure by boxes labeled with their item types, omitting item content and other metadata. Each arrow indicates a link between a document item and its parent document item as deduced from the hierarchy H_{DI}. In the DSG generator 25 of preferred embodiments, a recursive “structure-linker” process is employed to generate the DSGs in step 41 of FIG. 3. This process is explained below with reference to the flow-diagram of FIGS. 6a and 6b.

In step 50 of FIG. 6a, variables are initialized for the process as follows:

current_index=0;
previous_index=−1;
previous_label=“nothing” (corresponding to level 0 in hierarchy H_{DI} above);
previous_parent_label=“supertitle” (corresponding to level 1000 in hierarchy H_{DI} above);
previous_parent_index=−1.

An “index” here is the index number of a document item in the succession order of the parsed document, and can be indicated by an explicit index field in the metadata for document items. After initialization, the structure-linker process progresses through the succession of document items for a document, selecting each item in turn. For each selected item, the process identifies the index, denoted by “parent_index”, of its parent document item in the structural hierarchy of that document. For example, the parent index of a normal text paragraph should be the index of the nearest preceding heading (i.e., a document item with a label “section-level-x” for some number x), and the parent index of an item with label “section-level-x”, where x>1, should be the nearest preceding higher heading, i.e., a document item with label “section-level-y” and y<x.

Considering first the steps in column A of FIG. 6a, the variable “current_index” is incremented in step 51 to that of the next document item (initially the first item) in the item succession. In step 52, “H(current_label)” denotes the number allocated by hierarchy H_{DI} to the label (“current_label”) of the item with index “current_index”. “H(previous_label)” denotes the number allocated by H_{DI} to the label of the previous item in the succession (initialized to previous_label=“nothing” above, hence level 0 in hierarchy H_{DI}). Step 52 thus checks if the current and previous items are at the same hierarchy level in H_{DI}. If so, the items have the same parent item and the parent index of the current item is set to that of the previous item (previous_parent_index) in step 53. The variable previous_index is incremented in step 54, and the process reverts to re-entry point R and continues for the next item.

In response to decision “No” at step 52, operation proceeds to column B of FIG. 6a. In step 55 here, the DSG generator checks whether the hierarchy level of the current item is lower than that of the previous item (e.g. for a normal paragraph after a heading, or a list after/in a paragraph). If so, the previous item is the current item's parent. The current item's parent index is set accordingly in step 56, the variables are updated in step 57, and operation returns to re-entry point R for the next item.

In response to decision “No” at step 55, operation proceeds to column C. In step 58 here, the DSG generator checks whether the hierarchy level of the current item is lower than that of the previous item's parent (e.g., when proceeding from a paragraph in a level-2 section to a level-3 heading). If so, the current and previous items have the same parent item. The current item's parent index is set accordingly in step 59, variables are updated in step 60, and operation returns to re-entry point R.

In response to decision “No” at step 58, operation proceeds to FIG. 6b. This defines a recursion through the hierarchical document structure to search for the parent index of the current item. A parameter j is set to “previous_parent_index” in step 61, and step 62 then checks if j=−1, signifying a recursion-end because the current item has a higher hierarchy level than any before (e.g. for a main title that is not the first document item in the document). The parent index is then set to −1 in step 63 (to signify no parent). The variables are updated in step 64, and operation reverts to re-entry point R in FIG. 6a for the next item.

In response to decision “No” at step 62, the DSG generator loops through steps 65 through 67 back to step 62, in each loop comparing the hierarchy level of the current item with that of a progressively earlier ancestor (parent of a parent) of the previous item. At decision step 66 of any loop here, if the hierarchy level of the current item is less than that of the current ancestor, then that ancestor is the current item's parent. The parent index is set accordingly in step 68, parameters are updated in step 69, and operation reverts to FIG. 6a for the next item.

The structure-linker process defined above thus identifies a parent document item for each document item, sequentially in order of the document item succession, based on relative location in the hierarchy H_{DI} of the item-type of that item and the item-type of items earlier in the succession. The DSG for a document is fully defined by the parent indexes assigned to document items by this structure-linker process. It can be seen that all the parent indexes are identified by this process without going back linearly through the document. This provides a highly efficient DSG generation process, with complexity that only goes though document items once, in the original linear order, with a constant maximum amount of processing per item.

The extraction of entities from document items in step 42 of FIG. 3 can be performed using known NLP techniques such as regular expressions, LSTM (Long Short-term Memory) networks, conditional random fields (CRFs), convolutional neural networks (CNNs), recurrent neural networks (RNNs), transformer networks such as Bidirectional Encoder Representations from Transformers (BERT), possibly pretrained, and various other NER systems which can identify and label language items in text. The resulting annotated items, or named entities, may comprise noun phrases (i.e., sets of one or more words with a particular semantic meaning, whether single words or multiword expressions such as open/closed compound words), along with other entities such as numerical values and units, abbreviations, and so on.

Known NLP relation techniques may then be applied to identify relations between items. Examples here include: proximity analysis; regular expressions; grammar analysis; LSTM networks; CRFs, CNNs, and RNNs; classification systems based on transformer networks such as BERT (see, e.g., “Simple BERT Models for Relation Extraction and Semantic Role Labeling”, Peng Shi et al., arXiv:1904.05255v1 (2019)); transformer networks with additional head layers for relations between any pair of entities (see, e.g., “BERT-Based Multi-Head Selection for Joint Entity-Relation Extraction”, Weipeng Huang et al., arXiv:1908.05908v2 (2019) and “Joint Learning with Pre-trained Transformer on Named Entity Recognition and Relation Extraction Tasks for Clinical Analytics”, Miao Chen et al., ClinicalNLP@EMNLP 2020, pp. 234-242); and various other NER systems which can identify and label relations between language items in text.

In some embodiments, relations between language entities may be derived by analysis of individual document items, without considering overall document structure, as in the Corpus Processing Service (CPS) system referenced above. In step 43 of FIG. 3, nodes and edges of the KG may then be defined as in the CPS system, but with the addition of edges corresponding to parent-child relations. Here the KG generator defines nodes for respective document items and respective language items identified in the corpus, along with nodes for individual documents. Edges are defined between a node representing a document and nodes representing document items in that document. Further edges connect document item nodes to nodes representing the language entities in those items, and edges are defined between language entities for which relations were identified in step 42. Entities and relations may also be aggregated, resulting in additional nodes and edges, as described in the CPS reference. For example, entities can be aggregated by type, and additional nodes added for each entity type. Edges between such nodes aggregate relations between their constituent entities, and further edges connect these nodes to nodes for document items containing the constituent entities. Edges may also be weighted according to frequency of occurrence of particular terms in document items. All these operations can be implemented by so-called “dataflows” which include various tasks for defining nodes and edges for the KG to be constructed, with NLP models being embedded in particular tasks for extraction of entities and relations.

To create edges for parent-child relations in the knowledge graph, the KG generator 26 uses the DSGs to insert an edge between each document item node and the node for its parent document item, as indicated by the parent_index derived by the structure-linker in this embodiment. The structure-linker code can be embedded as a task-type for dataflows here, and an additional “link-properties” task can be provided to create the parent-child edges in the KG.

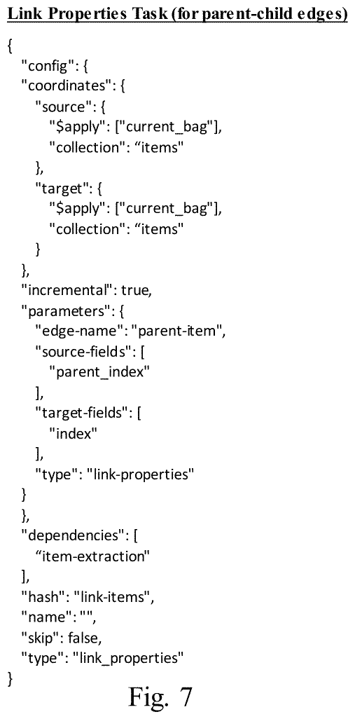

FIG. 7 shows an example of Python code for such a link-properties task. In this code, the main type (at the end) is “link_properties”, and the inner type field is similar (no subtype needed). In “coordinates”, the “source” and “target” collections (node types) are both “items”, meaning that this will be a relation among document item nodes, and “current bag” means within the database structure of the KG to be built here. “Source-fields” and “target-fields” signify that two document items in a document are linked if “parent_index” of the first item equals “index” of the second item. “Dependencies” indicates that this task can only start after “item-extraction” has finished, i.e., all items with their indexes etc. are ready, and “hash” is a unique name for this task, freely chosen.

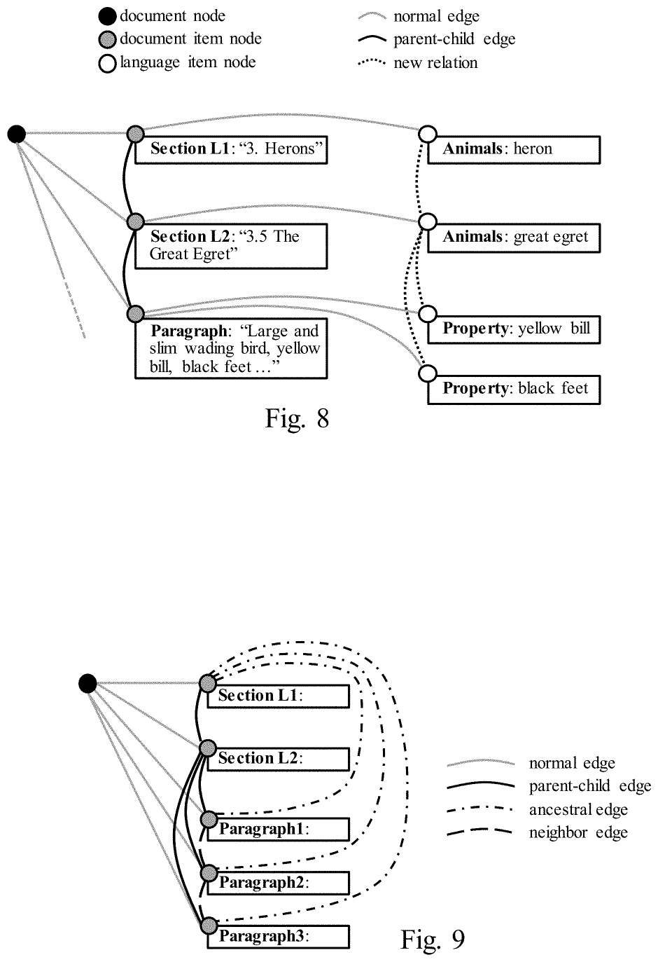

FIG. 8 is a schematic representation of nodes and edges in an exemplary knowledge graph generated by the above system. This shows only a small portion of a KG, here using information about birds as a simple illustration. Edges generated by the current CPS system (“normal edges”) are indicated by grey lines. Boxes attached to nodes indicate text of the corresponding items. This graph-section thus represents part of a document containing a level-1 section header “3. Herons”, with a sub-header under that “3.5 The Great Egret”, and a text paragraph under that sub-header. Language entities identified in these document items are shown on the right of the figure, with edges to their corresponding document item nodes. Parent-child edges inserted by the structure-linker are shown in black. The inclusion of these edges allows new information to be inferred from the document structure that would not be apparent from the normal edges alone. In this example, new relations can be inferred as indicated by dotted lines between the entities on the right. In particular, it can be deduced from the structure that the great egret is a type of heron, and that great egrets have the properties yellow bill and black feet.

The simple example above demonstrates how incorporation of document structure via parent-child edges can significantly increase the amount of information extracted from a document corpus and hence overall information encoded in the KG. Since KGDB 35 searches the KG by traversing edges of the graph, inclusion of parent-child edges allows this additional information to be readily extracted in search operations. The system thus extracts information implicit in a document structure which a human would naturally assimilate when reading the document, and encodes this in the KG. As a result, finding structural context of sentence- or paragraph-level search results is directly possible in the KG. The structural information also allows co-reference resolution. For example, “Permian Basin” may be mentioned in a header, but only referred to as “the basin” in the underlying section text. Embodiments of the invention thus offer more efficient search operations, more accurate and comprehensive search results, and improved operation of the technical applications exploiting these search results.

Additional structure-based edges can be included in the KGs generated by preferred embodiments. For example, in step 43 of FIG. 3, the KG generator can use the DSGs to define edges, representing ancestral relations, between nodes representing document items in each document and nodes representing at least one ancestor (parent-of-a-parent, grandparent of a parent, etc.) of their respective parent document items in the structural hierarchy for that document. Appropriate transitive closure rules can be applied to determined how far back to go in the ancestry when defining these “ancestral edges”. For example, ancestral edges may be inserted up to level-1 section headers only. Alternatively, for example, ancestral edges may be inserted to parent-of-parents only. Suitable rules can be applied here as deemed appropriate for the typical document format in a corpus. The KG generator can also use the DSGs to define “neighbor edges”, representing neighbor relations, between nodes representing document items and nodes representing their respective succeeding document items in the succession of items in each document.

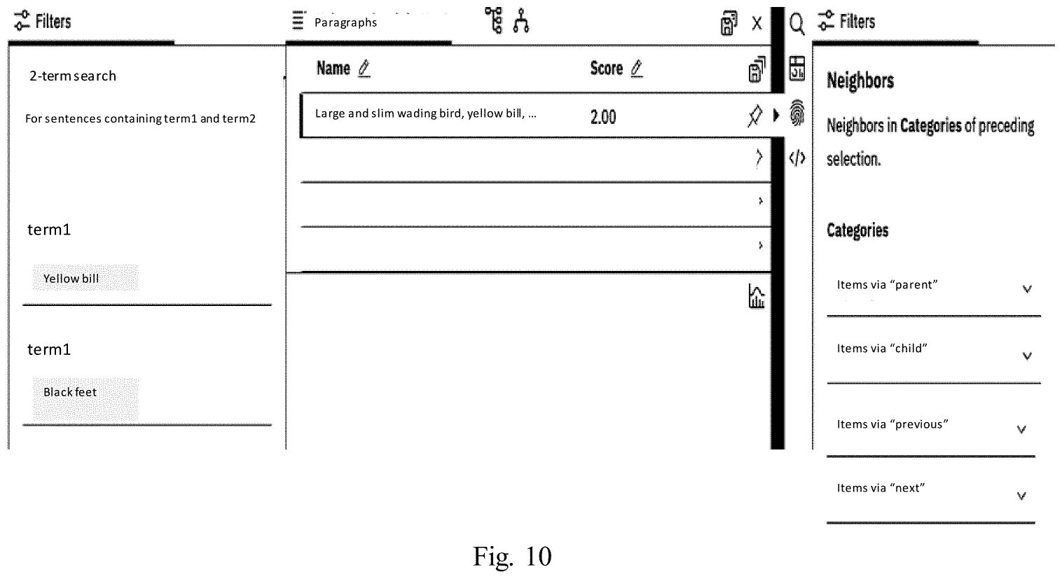

FIG. 9 shows a section of KG which includes such ancestral and neighbor edges. This figure shows document item nodes for a level-1 section header, a level-2 section header under that, and three paragraphs in the level-2 section. An ancestral edge is included between the node for each level-2 paragraph and the level-1 header node. Neighbor edges are included between nodes for successive level-2 paragraphs. These additional structure edges encode still further information in the KG. Ancestral edges allow relations between ancestor items beyond the parent level to be identified and extracted from the graph. Neighbor edges facilitate extraction of potentially relevant information from neighboring paragraphs which often contain mutually relevant information. Inclusion of these further structure edges offers more flexible and efficient search operations by traversing these edges in KGDB 35. For example, ancestral edges may be traversed in parallel with parent-child edges to retrieve information associated with multiple ancestors or descendants of a given node, or neighbor edges may be traversed to retrieve information from the succeeding/preceding document items for a given node. (Note that, depending on implementation in KGDB 35, bidirectional traversal of document structure edges may be enabled either by defining each edge as two component, oppositely-directed edges which can be individually selected for traversal (e.g., components labeled “parent of” and “child of” for a parent-child edge), or by defining one bi-directional edge and allowing searches to specify direction of traversal, e.g., “traverse to parent”, or “traverse to child”).

The I/F manager 27 of preferred embodiments provides a mechanism for selecting traversal of edges representing parent-child relations (and ancestral/neighbor relations where provided) between items in search operations for input search queries. FIG. 10 shows a screen-shot from an exemplary GUI 30 including such a mechanism, here for a KG with parent-child and neighbor edges. The left-hand panel of the GUI allows user-input of search terms, and the central panel displays document items containing those terms, here with a score rating how well results match the search query. The search shown here relates to the simple example of FIG. 8, with search terms “yellow bill” and “black feet”. This search extracts the level-2 paragraph of FIG. 8 in the search results. The right-hand panel of the GUI allows the user to select options for traversing parent-child and/or neighbor edges from the node for any document item displayed in the search results, here as clickable options for “Items via parent”, “Items via child”, “Items via previous”, “Items via next”. Running this further search then displays the additional document items located by traversing the structure edges. For example, clicking “items via parent” would find “3.5 The Great Egret”, where great egret would be marked as an animal class. Selecting a “properties” option (not visible here) in the GUI would then display the properties “yellow bill” and “black feet”. With an ancestral edge between the level-2 paragraph and section 1 header nodes in FIG. 8, a corresponding search operation for “Items by ancestor” would find the level 1 header “3. Herons”. The additional information encoded in the document structure is thus easily accessible to a searcher via the GUI.

Various other mechanisms can of course be envisaged for selecting traversal of structure edges in user-constructed search queries. As a further example, draggable icons may be provided for different types of nodes, and traversal of different types of structure edges, in workflows constructed by the user in a workflow construction pane of the GUI.

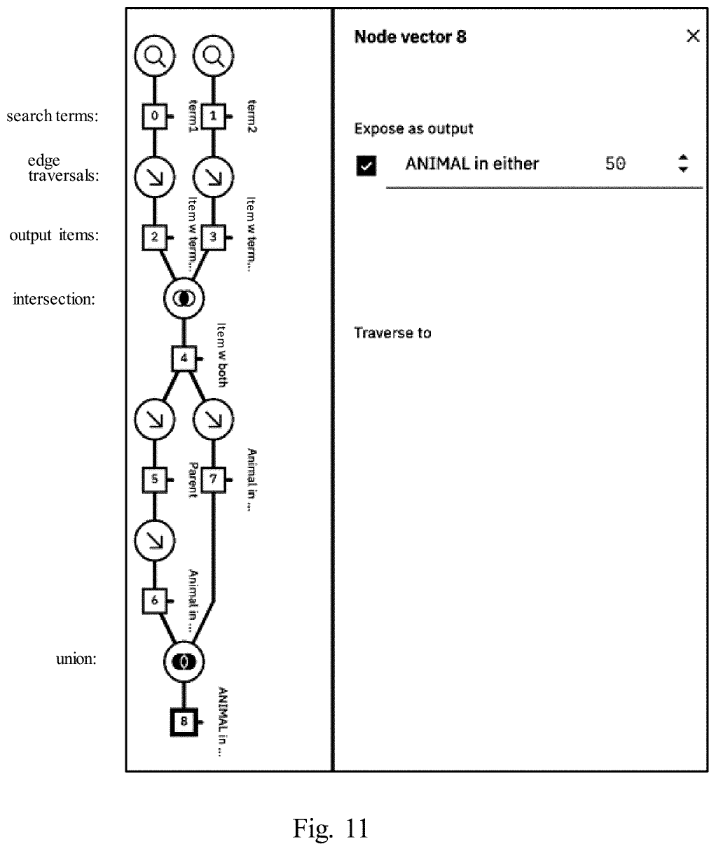

For more complex search tasks, the I/F manager of preferred embodiments provides predefined search templates (search workflows), each defining a particular type of search query involving traversal of a structure edge, in GUI 30. These structure-traversing workflows can be constructed from basic component operations such as search, edge traversal, filter, intersection, and union. FIG. 11 shows a screenshot of a GUI showing one such workflow. The left-hand panel shows the workflow structure, and the right-hand panel provides user-selectable options for specifying the inputs/outputs required for particular components (“node vectors”) represented by numbered boxes 0 to 8 in the workflow. This panel also allows selection of edge-types for edge traversals in the workflow (options not visible in the panel view shown). In the workflow here, node vectors 0 and 1 allow the user to input search terms, “term1” and “term2”. The following arrows represent edge traversals to output nodes 3 and 4 representing document items containing term1 and term2 respectively. Then an intersection follows to get document items with both search terms at node 4. The right branch of the workflow, to output node 7, looks for an animal directly in the node-4 items. The left branch of the workflow defines a parent-child edge traversal to parents, at output node 5, of the node-4 items, and then traverses to animals in those items. The union then gives results from both branches at output node 8.

The FIG. 11 workflow could be differently customized by a user, e.g. to specify edge traversals to ancestor or neighbor document items. Basic workflows may also be supplemented with additional and/or longer branches, e.g. branches for higher-level headers or another branch to the neighbor paragraphs, by providing draggable icons to add operations and output nodes to the workflow.

Where structure-aware NLP models are employed in KG generator 26, these can be applied to derive additional relations between entities in structurally-related document items. The KG generator then includes additional edges explicitly encoding these relations in the KG. For example, edges may be added for the new relations indicated by dotted lines in FIG. 8. Structure-aware NLP models are applied to a linked structure of document items. This can be done either by giving a task access to the entire set of document items in a document, or by passing the task a sub-structure, such as an item and its parent item (and other ancestors where provided). Inside the task, there are also essentially two options: the task can call conventional, intra-item NLP and only use the structure afterwards (e.g., via predefined rules); or the task can input a multi-item structure into conventional NLP models (e.g., copy the header sequence for a paragraph to the beginning of this paragraph, possibly with separators, and call the NLP on this extended paragraph). Examples of such structure-aware NLP techniques are described below for the KG section of FIG. 8.

In a first implementation, a structure-aware NLP task for “animal-property-value”, applied to the level-2 paragraph in FIG. 8, will first extract (among other things) the properties “bill color” and “foot color” with values “yellow” and “black”, respectively. It may also find the animal-classes “bird” and/or “wading bird” directly in this paragraph, but it will also look in parent/ancestor items for animal-species (which another instance of basic NLP has already identified in those items). Thus it will find the animal-species “great egret” (and another animal-class “heron”). It can then apply a rule (or machine-learned knowledge) that animal-properties are more likely to be stated about single species than classes. Thus it will provide the triples “great egret—bill color—yellow” and “great egret—foot color—black” as its highest-confidence results. Such a task can be flexible about how far back in the ancestry of a node to search if it has already found a likely result.

In a second implementation, a structure-aware NLP task may take the complete structural sequence “3 Heron∥3.5 Great Egret∥Large and slim wading bird, yellow-bill, black feet . . . ” (where “∥” denotes a separation indicator) like a single paragraph that is passed to basic NLP. What happens then depends on the type of basic NLP. If there are three different base NLP models for animals, properties, and values, the overall task will get the animal classes “heron”, “bird”, “wading bird”, the properties “bill color” and “foot color”, and the values “yellow” and “black” (and possibly the vaguer properties “large” and “slim”). The overall task may then piece these elements together (e.g. using proximity/grammatical criterion as for basic relation models) to the same triples as the first implementation above. A more powerful basic NLP model can be trained to directly find relations. If this was trained (or at least pretrained) on normal sentences (i.e., without pre-pended headings), the overall task may transform the headers to be closer to normal sentences, e.g., it may strip off the header numbers and input the following to the NLP model: “Heron, great egret, large and slim . . . ”. Alternatively, or in addition, NLP finetuning including the header structures can be performed.

It will be seen that the embodiments described offer significant improvements in information extraction systems. However, numerous changes and modifications can be made to the exemplary embodiments described. For example, I/F manager 27 may provide various other features in GUI 30, such as views representing topology of all, or selected parts, of a KG to show the structure-derived edges. Relation edges in the KG may be weighted in various ways, e.g., language-entity nodes may be weighted according to confidence values output by an NER system. Item-label hierarchies H_{DI} can be defined in any convenient manner to indicate relative hierarchical positions of the item labels, and various other processes can be envisaged for generating the DSGs. Also, while the FIG. 2 embodiment includes a document analyzer 24, embodiments may be applied to a pre-existing parsed document corpus 31.

Steps of flow diagrams may be implemented in a different order to that shown and some steps may be performed in parallel where appropriate. In general, where features are described herein with reference to a method embodying the invention, corresponding features may be provided in a system/computer program product embodying the invention, and vice versa.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for producing a searchable representation of information contained in a corpus of documents, the method comprising:
for each document:
generating a document structure graph indicating a structural hierarchy of document items in that document based on a predefined hierarchy of predetermined item-types, and
linking document items to a parent document item in the structural hierarchy;
generating a knowledge graph comprising first nodes, representing document items in the corpus and second nodes representing language items identified in those document items, interconnecting the first nodes and second nodes by edges representing a defined relation between items represented by the nodes interconnected by that edge;
storing the knowledge graph in a knowledge graph database; and
producing said searchable representation by traversing edges of the graph, in response to input search queries.

2. A method as claimed in claim 1 including:
receiving a search query to the knowledge graph database;
searching the knowledge graph by traversing edges of the graph to extract information responsive to the search query; and
outputting the extracted information for the search query.

3. A method as claimed in claim 1 wherein said predetermined item-types comprise at least a plurality of item types selected from the group consisting of: document title; subtitle; document author; document abstract; author affiliation; chapter; section heading; subsection heading; paragraph; table; picture; caption; keyword; citation; table-of-contents; list item; sub-list item; table; table column-header; table row-header; table cell; list in table cell; code; form; formula; and footnote.

4. A method as claimed in claim 1 wherein said language items comprise named entities.

5. A method as claimed in claim 1 wherein the knowledge graph further includes edges, representing ancestral relations, between nodes representing document items in each document and nodes representing at least one ancestor of their respective parent document items, in said structural hierarchy for that document.

6. A method as claimed in claim 5 including, in generating the knowledge graph:
applying a machine learning model to identify relations between language items identified in document items and language items identified in nodes representing at least one ancestor of their respective parent document items in said structural hierarchy; and
for each relation between a pair of language items identified by said model, including an edge, representing that relation, in the knowledge graph between the nodes representing those language items.

7. A method as claimed in claim 5 including:
providing a graphical user interface, for display by a user computer, for input of search queries to the knowledge graph database; and
providing in said interface a mechanism for selecting traversal of edges representing ancestral relations between document items in search operations for input search queries.

8. A method as claimed in claim 5 including:
providing a graphical user interface, for display by a user computer, for input of search queries to the knowledge graph database; and
providing in said interface at least one predefined template defining a type of search query, said template specifying traversal of an edge representing an ancestral relation between document items in a search operation for said type of search query.

9. A method as claimed in claim 1 wherein the knowledge graph further includes edges, representing neighbor relations, between nodes representing document items in each document and nodes representing their respective succeeding document items in said succession of document items, for that document.

10. A method as claimed in claim 6 including:
providing a graphical user interface, for display by a user computer, for input of search queries to the knowledge graph database; and
providing in said interface at least one predefined template defining a type of search query, said template specifying traversal of an edge representing a neighbor relation between document items in a search operation for said type of search query.

11. A method as claimed in claim 9 including:
providing a graphical user interface, for display by a user computer, for input of search queries to the knowledge graph database; and
providing in said interface a mechanism for selecting traversal of edges representing neighbor relations between document items in search operations for input search queries.

12. A method as claimed in claim 1 wherein the knowledge graph includes:
edges between a node representing a document item and nodes representing language items identified in that document item; and
edges between a node representing a document and nodes representing document items in that document.

13. A method as claimed in claim 1 wherein generating the knowledge graph further comprises:
applying a machine learning model to identify relations between language items identified in document items and language items identified in their respective parent document items; and
for each relation between a pair of language items identified by said model, including an edge, representing that relation, in the knowledge graph between the nodes representing those language items.

14. A method as claimed in claim 1 including:
providing a graphical user interface, for display by a user computer, for input of search queries to the knowledge graph database; and
providing in said interface a mechanism for selecting traversal of edges representing parent-child relations between document items in search operations for input search queries.

15. A method as claimed in claim 1 including:
providing a graphical user interface, for display by a user computer, for input of search queries to the knowledge graph database; and
providing in said interface at least one predefined template defining a type of search query, said template specifying traversal of an edge representing a parent-child relation between document items in a search operation for said type of search query.

16. A method as claimed in claim 1 including generating the document structure graph for a document via a recursive process which identifies a parent document item for each document item, sequentially in order of said succession, in dependence on relative location in said predefined hierarchy of the item-type of that item and the item-type of items earlier in said succession.

17. A method as claimed in claim 1 including preprocessing each document in said corpus to parse the document into said succession of document items annotated with said item-types.

18. A computer program product for producing a searchable representation of information contained in a corpus of documents, said computer program product comprising a computer readable storage medium having program instructions embodied therein, the program instructions being executable by a computing system to cause the computing system to:
define a document structure graph indicating a structural hierarchy of the document items in that document based on a predefined hierarchy of said predetermined item-types, for each document;
link document items to a parent document item in the structural hierarchy;
generate a knowledge graph comprising nodes representing document items in the corpus, nodes representing language items identified in those document items, and edges representing a defined relation between items represented by the nodes interconnected by that edge; and
store the knowledge graph in a knowledge graph database; and
search the knowledge graph, by traversing edges of the graph in response to input search queries.

19. A computer program product as claimed in claim 18 wherein said program instructions are further executable, in response to input of a search query to the knowledge graph database, to cause the system to search the knowledge graph by traversing edges of the graph to extract information responsive to the search query, and to output the extracted information for the search query.

20. An information extraction system for producing a searchable representation of information contained in a corpus of documents each comprising a succession of document items of predetermined item-types defined for the corpus, the system comprising:
memory for storing the documents;
document graph logic adapted, for each document, to generate a document structure graph indicating a structural hierarchy of document items in a document based on a predefined hierarchy of predetermined item-types, for each document and to link document items to a parent document item in the structural hierarchy;
a knowledge graph generator adapted to generate a knowledge graph comprising first nodes, representing document items in the corpus and second nodes representing language items identified in those document items, interconnecting the first nodes and second nodes by edges representing a defined relation between items represented by the nodes interconnected by that edge; and
a knowledge graph database for storing the knowledge graph to produce said searchable representation of information contained in the corpus, the knowledge graph database being adapted to search the knowledge graph, by traversing edges of the graph, in response to input search queries.
